(19) United States
(12) Patent Application Publication
(10) Pub. No.: US 2023/0007276 A1
(43) Pub. Date: Jan. 5, 2023

(54) Encoding Device and Method for Video Analysis and Composition

(71) Applicant: Videopura, LLC, Delray Beach, FL (US)

(72) Inventor: Velibor Adzic, Canton, GA (US)

(73) Assignee: Videopura, LLC

(21) Appl. No.: 17/902,938

(22) Filed: Sep. 5, 2022

Related U.S. Application Data
(63) Continuation of application No. PCT/US2021/020848, filed on Mar. 4, 2021.
(60) Provisional application No. 62/985,294, filed on Mar. 4, 2020.

(51) Int. Cl. H04N 19/167; G06V 10/25

(52) U.S. Cl. CPC H04N 19/167; G06V 10/25

(57) ABSTRACT

An encoding device for video analysis and composition includes circuitry configured to receive an input video having a first data volume, determine at least a region of interest of the input video, and encode at least an output video as a function of the input video and the at least a region of interest, wherein the at least an output video has at least a second data volume, and the at least a second data volume is less than the first data volume.

### CROSS-REFERENCE TO RELATED APPLICATIONS

This application claims the benefit of priority of U.S. Provisional Application Ser. No. 62/985,294, filed on Mar. 4, 2020, and entitled “System for video analysis with a compositional encoder,” which is incorporated by reference herein in its entirety.

### FIELD OF THE INVENTION

The present invention generally relates to the field of video compression. In particular, the present invention is directed to encoding device and method for video analysis and composition.

### BACKGROUND

Video capture and processing, particularly of large and complex phenomena such as sporting events, public speeches and ceremonies, or the like, suffers from a surfeit of information, forcing compromises between focus on key aspects of scenes to be captured at the expense of overall information content, or breadth at the expense of focus.

### SUMMARY OF THE DISCLOSURE

In an aspect, an encoding device for video analysis and composition includes circuitry configured to receive an input video having a first data volume, determine at least a region of interest of the input video, encode at least an output video as a function of the input video and the at least a region of interest, wherein the at least an output video has at least a second data volume and the at least a second data volume is less than the first data volume.

In another aspect, a method of video analysis and composition includes receiving, by an encoding device, an input video having a first data volume, determining, by the encoding device, at least a region of interest of the input video and encoding, by the encoding device, at least an output video as a function of the input video and the at least a region of interest, wherein the at least an output video has at least a second data volume and the at least a second data volume is less than the first data volume.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram illustrating an exemplary embodiment of an encoding device for video analysis and composition;

FIG. 2 is a block diagram illustrating an exemplary embodiment of a system for video analysis and composition;

FIG. 3 is a block diagram illustrating an exemplary embodiment of a system for video analysis and composition;

FIG. 4 is a schematic diagram illustrating a process of video analysis and composition;

FIG. 5 is a schematic diagram illustrating a process of video analysis and composition;

FIG. 6 is a schematic diagram illustrating a process of video analysis and composition;

FIG. 7 is a block diagram illustrating an exemplary embodiment of a video;

FIG. 8 is a block diagram illustrating an exemplary embodiment of an encoder;

FIG. 9 is a block diagram illustrating an exemplary embodiment of a decoder;

FIG. 10 is a block diagram illustrating an exemplary embodiment of a machine-learning module;

FIG. 11 is a schematic diagram illustrating an exemplary embodiment of a neural network;

FIG. 12 is a schematic diagram illustrating an exemplary embodiment of a neural network node;

FIG. 13 is a flow diagram illustrating an exemplary method of and

FIG. 14 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted. Like reference symbols in the various drawings indicate like elements.

### DETAILED DESCRIPTION

Presented in this disclosure is an encoding device for video processing that analyzes and encodes video to serve needs of distinct end users. System may include an input video analyzer and/or a video encoder that compose parts of analyzed input video into output videos 128 intended for end users. Regions of interest may be selected based on user or recipient device indications of needs, using intelligent programming, and/or through motion detection.

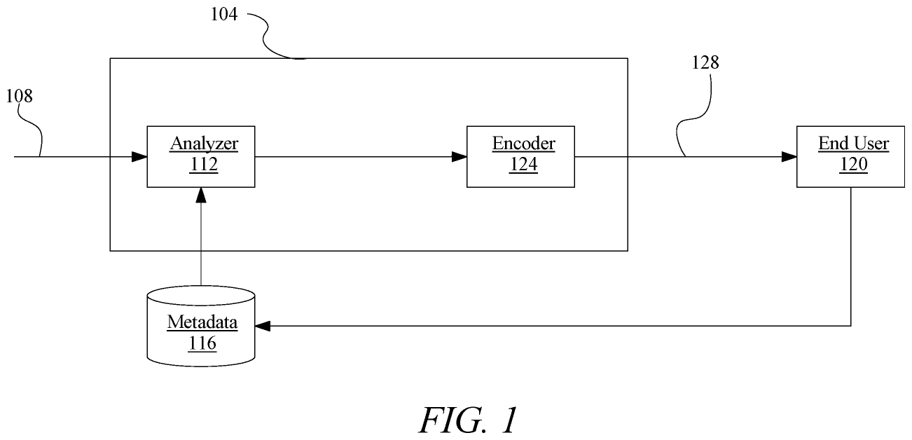

Referring now to FIG. 1, an exemplary embodiment of an encoding device 104 for video analysis and composition is illustrated. Encoding device 104 may be implemented using any digital electronic circuitry as described in this disclosure. Encoding device 104 may include any computing device as described in this disclosure, including without limitation a microcontroller, microprocessor, digital signal processor (DSP) and/or system on a chip (SoC) as described in this disclosure. Encoding device 104, and/or any module and/or component thereof as described in further detail in this disclosure, may be configured by any form of hardware, software, or firmware configuration and/or manufacture, or any combination thereof. Encoding device 104 may include, be included in, and/or communicate with a mobile device such as a mobile telephone or smartphone. Encoding device 104 may include a single computing device operating independently, or may include two or more computing device operating in concert, in parallel, sequentially or the like; two or more computing devices may be included together in a single computing device or in two or more computing devices. Encoding device 104 may interface or communicate with one or more additional devices as described below in further detail via a network interface device. Network interface device may be utilized for connecting encoding device 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. For example, encoding device 104 may include, without limitation, a computing device or cluster of computing devices in a first location and a second computing device or cluster of computing devices in a second location. Encoding device 104 may include one or more computing devices dedicated to data storage, security, distribution of traffic for load balancing, and the like. Encoding device 104 may distribute one or more computing tasks as described below across a plurality of computing devices of computing device, which may operate in parallel, in series, redundantly, or in any other manner used for distribution of tasks or memory between computing devices. Encoding device 104 may be implemented using a “shared nothing” architecture in which data is cached at the worker, in an embodiment, this may enable scalability of system 100 and/or computing device.

With continued reference to FIG. 1, encoding device 104 may be designed and/or configured to perform any method, method step, or sequence of method steps in any embodiment described in this disclosure, in any order and with any degree of repetition. For instance, encoding device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Encoding device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

As a non-limiting example, and with further reference to FIG. 1, encoding device 104 and/or one or more modules and/or components thereof may be configured to accept input video 108. This may be performed, without limitation, by an analyzer 112, which may be implemented in any manner suitable for implementation of any computing device, module, and/or component of encoding device 104 as described above. Modules and/or components described as included in analyzer 112 are presented for exemplary purposes only; functions and/or structure pertaining to each such module and/or component may be implemented in any alternative or additional manner in encoding device 104 and/or any component, module, and/or device incorporated in or communicatively connected to encoding device 104, in any manner that may occur to persons skilled in the art, upon reviewing the entirety of this disclosure.

Still referring to FIG. 1, input video 108 may have any original source, including without limitation computer-generated video, animated video, and/or video captured by a recording device such as without limitation a video camera. Alternatively or additionally analyzer 112 and/or encoding device 104 may receive input video 108 as a stream and/or bitstream and decode the stream and/or bitstream into a video, for instance by parsing out video, audio and/or metadata sub-streams of the stream and/or bitstream. Decoding may be performed, without limitation, as described in further detail below.

Further referring to FIG. 1, analyzer 112 and/or encoding device 104 may analyze components of the input stream, such as one or more video frames, audio tracks, subtitles, and/or any additional metadata that is present in the input stream and/or input video or obtained from an outside source of metadata information and/or feedback 116; outside source may include an end user 120 and/or an end user device. One example of metadata may include without limitation an output of a day light sensor that can detect low light conditions. A non-limiting example of analysis may be a computer vision algorithm for object detection in received video frames that locates and identifies objects of interest and/or persons, for instance and without limitation using at least a neural network and/or machine learning model as described in further detail below. Another non-limiting example of analysis may include a computer vision algorithm that recognizes motion and can identify action that is conducted across the video frames, such as walking, running, explosions, or the like; identification may be performed by a neural network and/or machine-learning model as described below. Yet another non-limiting example of analysis may include a spectral analysis algorithm that analyzes audio track and identifies voice and conversation, for instance using a neural network and/or machine-learning model as described below. Yet another example of analysis may include a natural language processing algorithm that extracts portions of an input video associated with certain words and word constructions in a subtitle track.

Still referring to FIG. 1, natural language analysis may be performed, without limitation, using a language processing module, which may be implemented on encoding device 104 and/or on another device in communication with encoding device 104. Modules and/or components described as included in a language processing module are presented for exemplary purposes only; functions and/or structure pertaining to each such module and/or component may be implemented in any alternative or additional manner in encoding device 104 and/or any component, module, and/or device incorporated in or communicatively connected to encoding device 104, in any manner that may occur to persons skilled in the art, upon reviewing the entirety of this disclosure. Language processing module may include any hardware and/or software module. Language processing module may be configured to extract, from the one or more documents, one or more words. One or more words may include, without limitation, strings of one or more characters, including without limitation any sequence or sequences of letters, numbers, punctuation, diacritic marks, engineering symbols, geometric dimensioning and tolerancing (GD&T) symbols, chemical symbols and formulas, spaces, whitespace, and other symbols, including any symbols usable as textual data as described above. Textual data may be parsed into tokens, which may include a simple word (sequence of letters separated by whitespace) or more generally a sequence of characters as described previously. The term “token,” as used herein, refers to any smaller, individual groupings of text from a larger source of text; tokens may be broken up by word, pair of words, sentence, or other delimitation. These tokens may in turn be parsed in various ways. Textual data may be parsed into words or sequences of words, which may be considered words as well. Textual data may be parsed into “n-grams”, where all sequences of n consecutive characters are considered. Any or all possible sequences of tokens or words may be stored as “chains”, for example for use as a Markov chain or Hidden Markov Model.

Further referring to FIG. 1, language processing module may operate to produce a language processing model. Language processing model may include a program automatically generated by computing device and/or language processing module to produce associations between one or more words extracted from at least a document and detect associations, including without limitation mathematical associations, between such words. Associations between language elements, where language elements include for purposes herein extracted words, relationships of such categories to other such term may include, without limitation, mathematical associations, including without limitation statistical correlations between any language element and any other language element and/or language elements. Statistical correlations and/or mathematical associations may include probabilistic formulas or relationships indicating, for instance, a likelihood that a given extracted word indicates a given category of semantic meaning. As a further example, statistical correlations and/or mathematical associations may include probabilistic formulas or relationships indicating a positive and/or negative association between at least an extracted word and/or a given semantic meaning; positive or negative indication may include an indication that a given document is or is not indicating a category semantic meaning. Whether a phrase, sentence, word, or other textual element in a document or corpus of documents constitutes a positive or negative indicator may be determined, in an embodiment, by mathematical associations between detected words, comparisons to phrases and/or words indicating positive and/or negative indicators that are stored in memory at computing device, or the like.

Still referring to 1, language processing module and/or diagnostic engine may generate the language processing model by any suitable method, including without limitation a natural language processing classification algorithm; language processing model may include a natural language process classification model that enumerates and/or derives statistical relationships between input terms and output terms. Algorithm to generate language processing model may include a stochastic gradient descent algorithm, which may include a method that iteratively optimizes an objective function, such as an objective function representing a statistical estimation of relationships between terms, including relationships between input terms and output terms, in the form of a sum of relationships to be estimated. In an alternative or additional approach, sequential tokens may be modeled as chains, serving as the observations in a Hidden Markov Model (HMM). HMMs as used herein are statistical models with inference algorithms that that may be applied to the models. In such models, a hidden state to be estimated may include an association between an extracted words; phrases; and/or other semantic units. There may be a finite number of categories to which an extracted word may pertain; an HMM inference algorithm, such as the forward-backward algorithm or the Viterbi algorithm, may be used to estimate the most likely discrete state given a word or sequence of words, Language processing module may combine two or more approaches. For instance, and without limitation, machine-learning program may use a combination of Naive-Bayes (NB), Stochastic Gradient Descent (SGD), and parameter grid-searching classification techniques; the result may include a classification algorithm that returns ranked associations.

Continuing to refer to FIG. 1, generating language processing model may include generating a vector space, which may be a collection of vectors, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each vector in an n-dimensional vector space may be represented by an n-tuple of numerical values. Each unique extracted word and/or language element as described above may be represented by a vector of the vector space. In an embodiment, each unique extracted and/or other language element may be represented by a dimension of vector space; as a non-limiting example, each element of a vector may include a number representing an enumeration of co-occurrences of the word and/or language element represented by the vector with another word and/or language element. Vectors may be normalized, scaled according to relative frequencies of appearance and/or file sizes. In an embodiment associating language elements to one another as described above may include computing a degree of vector similarity between a vector representing each language element and a vector representing another language element; vector similarity may be measured according to any norm for proximity and/or similarity of two vectors, including without limitation cosine similarity, which measures the similarity of two vectors by evaluating the cosine of the angle between the vectors, which can be computed using a dot product of the two vectors divided by the lengths of the two vectors. Degree of similarity may include any other geometric measure of distance between vectors.

Still referring to FIG. 1, language processing module may use a corpus of documents to generate associations between language elements in a language processing module, and diagnostic engine may then use such associations to analyze words extracted from one or more documents and determine that the one or more documents indicate significance of a category. In an embodiment, language module and/or encoding device may perform this analysis using a selected set of significant documents, such as documents identified by one or more experts as representing good information; experts may identify or enter such documents via graphical user interface, or may communicate identities of significant documents according to any other suitable method of electronic communication, or by providing such identity to other persons who may enter such identifications into encoding device 104. Documents may be entered into a computing device by being uploaded by an expert or other persons using, without limitation, file transfer protocol (FTP) or other suitable methods for transmission and/or upload of documents; alternatively or additionally, where a document is identified by a citation, a uniform resource identifier (URI), uniform resource locator (URL) or other datum permitting unambiguous identification of the document, diagnostic engine may automatically obtain the document using such an identifier, for instance by submitting a request to a database or compendium of documents such as JSTOR as provided by Ithaka Harbors, Inc. of New York.

Further referring to FIG. 1, yet another example of analysis may include a parsing algorithm that receives metadata from an end user and manipulates video according to desired effects, such as resizing, cropping, and/or change of encoding parameters according to the network conditions. A further non-limiting example of analysis may include a binning algorithm that bins adjacent pixels to improve the quality of image under lowlight conditions. Such lowlight conditions may be measured using a light and/or daylight sensor that can detect low light conditions. Depending on light conditions the system automatically adjusts the resolution of output video 128. Under lowlight conditions, video resolution may be reduced by pixel binning to improve image and video quality. The amount of resolution reduction may be driven by a light level detected, with lower light levels producing a lower resolution output.

Still referring to FIG. 1, in a non-limiting a user may be watching video on his or her mobile phone or similar device. As user walks out of a low-light room into daylight resolution and dynamic range of video may change to keep the video watchable. Data describing exterior light levels may be sent automatically from the phone's light sensor in a process analogous to a process used when phones change brightness automatically. Inversely, when user transitions into a lower light environment a video may be modified to a lower resolution and dynamic range.

Further referring to FIG. 1, encoding device 104 may adjust allocation of resources for a first type of services based on detection of a second type of services. For instance, where a user of a network including encoding device 104 and/or of encoding device 104 is using conversational services such as ZOOM conferencing as provided by Zoom Video Communications, Inc. of San Jose, Calif., which may be sensitive to bandwidth, encoder may provide to live streaming applications parameters to reduce bandwidth usage, for instance and without limitation by decreasing resolution, introducing buffering delays, or the like. As a further non-limiting example, encoding device 104 may modify resolution and/or otherwise adjust streaming settings based on signal strength of a device transmitting a video stream; signal strength of a user device may be detected by, e.g., encoding device 104, a device incorporating or incorporated in encoding device 104, a node connecting to user device, and/or user device itself, and a value representing signal strength may be recorded by and/or transmitted to encoding device 104, which may vary one or more parameters of a video stream accordingly. Variation in signal strength or signal strength may be an indicator of network conditions, some of which may be predictive of loss rate in the network. Presence of other users sharing a network and/or services used by other users sharing the network may affect network conditions and may be used to adapt encoding parameters.

With continued reference to FIG. 1, encoding device 104 may adapt any encoding parameters described herein, including contrast, brightness, resolution, frame rate, or the like. Adjustment of coding parameters may further include cropping or otherwise limiting an output video to a region of interest; for instance, where encoding device 104 determines a region or regions of interest as described in this disclosure, encoding device may output a video containing just the determined region or regions of interest and excluding other portions to save bandwidth or otherwise mitigate effects of detected circumstances. Where network capacity and/or other parameters as described in this disclosure improve, encoding device 104 may reverse mitigating actions, such as by transmitting output video with a larger region of interest and/or not limited to a region of interest, increasing contrast, frame rate, and/or resolution, or the like.

In an embodiment, and still referring to FIG. 1, encoding device 104 may be configured to accept an input video 108 having a first data volume and identify at least a region of interest in the input video 108, where region of interest. A “region of interest.” as used in this disclosure, is a region of video having information relevant to a desired output video 128. Region of interest may include a region having a high degree of motion. In other words, determining at least a region of interest may include detecting an area of motion in the input video and determining the at least a region of interest based on the area of motion. An area of motion may be detected by analysis of motion vectors, for instance and without limitation as determined in any encoding and/or encoder-related process as described in this disclosure. Encoding device 104 may compare a rate of motion indicated by motion vectors to a predefined threshold, where exceeding the predefined threshold may indicate that an area having a motion vector exceeding the predefined threshold is an area of motion. Predetermined threshold may be a constant defined and/or stored on or at encoding device 104. Alternatively or additionally, encoding device may calculate predetermined threshold. Calculation of predetermined threshold may be performed by detecting an average, median, or other statistical or aggregate representation of a typical amount of motion in video frame, and then selecting a threshold that is some percentage and/or amount in excess thereof. Predetermined threshold may be case-specific; for instance, predetermined threshold may be set a first way for a first type of video, subject of video, and/or category of user instruction. As a non-limiting example, a threshold identifying an area of motion may be higher for an athletic event than for a seminar or conference. Degree, type, variation, or other attributes of motion may alternatively or additionally be parameters used for classification and/or other neural network and/or machine-learning processes and/or models for determination of regions of interest as described in further detail below.

Still referring to FIG. 1, determining the at least a region of interest may include identifying at least a feature of interest in the input video and determining the at least a region of interest based on the at least a feature of interest. A “feature of interest” as used herein is a visual, audio, or other feature to be included in an output video 128. At least a feature of interest may include at least an audio feature. At least a feature of interest may include at least visual feature, which may include any feature of displayed and/or picture data as described above. At least a feature of interest may include at least an element of metadata.

Continuing to refer to FIG. 1, encoding device 104 may be configured to identify the at least a feature of interest using at least a recipient input. For instance and without limitation, encoding device 104 may identify the at least a feature of interest by receiving at least a supervised annotation indicating the at least a feature of interest identifying the at least a feature of interest using the at least a supervised annotation. At least a recipient input may be received in the form of feedback

Alternatively or additionally, and still referring to FIG. 1, encoding device 104 may identify the at least a feature of interest using a neural network. For example, and without limitation, a first neural network configuration may be used to detect faces in video, a second neural network configuration may be used to detect license plates in a video, a third neural network configuration may be used to produce a set of features used by other neural networks or applications, and a fourth neural network configuration may be used to detect backpacks and coats. A neural network configuration may fully specify a neural network. A neural network configuration may include all information necessary to process input data with that neural network.

Encoding device 104 may use a machine-learning model, machine-learning process, and/or neural network, as described in further detail below, to perform above-described tasks and/or analysis. Machine-learning model parameters, machine-learning process parameters, neural network parameters, and/or neural network configuration may be received, as described above, as supplemental data; alternatively, encoding device 104 may train a machine-learning model, machine-learning process, and/or neural network using training data and/or algorithms, for instance and without limitation as described below.

With continued reference to FIG. 1, neural networks may be executed on hardware acceleration designed for neural networks. Encoding device 104 may have one or more hardware acceleration units to speed up execution of a neural network. In an embodiment, where a device has one hardware acceleration unit and selects one or more neural networks and/or neural network configurations to be executed on a single frame, video, element or collection of audio data, and/or element or collection of metadata, encoding device 104 may load and execute one neural network at a time. As a further non-limiting example, where encoding device 104 includes and/or has access to multiple hardware acceleration units, encoding device 104 may execute two or more neural networks concurrently through parallel processing. Encoding device 104 may assign a neural network to a hardware acceleration unit that may execute that neural network, where assignment may depend, without limitation, on a size of the neural network and/or a capacity of the hardware acceleration unit.

Still referring to FIG. 1, encoding device 104 may be configured to receive an output bitstream recipient characteristic and select the neural network from a plurality of neural networks as a function of the output bitstream recipient characteristic. An “output bitstream recipient characteristic,” as used in this disclosure, is any information concerning features a recipient and/or recipient device may require, an application for which recipient device will use a bitstream and/or sub-stream, and/or any data from which encoding device 104 may determine such features and/or applications. Neural network may be selected, without limitation, by classification, retrieval from a database, or the like.

Still referring to FIG. 1, a spatial region label may be added for each region signaled in a bitstream. A “spatial region label,” as used in this disclosure, is a text descriptor such as without limitation “face,” “car,” “foreground,” “background,” or the like. A spatial region label may be signaled once in picture header or a header common for a group of frames such as a sequence header or sequence parameter set. Encoding device 104 may alternatively or additionally signal at block and/or spatial region level to indicate one or more labels contained in such blocks and/or spatial regions. Encoding device 104 may signal if a given frame includes a feature of interest; for instance, encoding device 104 may signal if a frame includes a face, skin, a vehicle, or the like. Encoding device 104 may signal and/or indicate semantics information in a frame, where semantics information may describe objects and/or relationships among objects. For instance, and without limitation, a scene may have objects such as a sofa, a television, a desk, or the like, and may be semantically described as a living room and/or an indoor scene. Different levels of semantics may be used to describe different aspects of a scene and/or picture; for example, one level of semantics may describe an overall scene, while another may describe a region and/or detail of the scene, and the like. Content analysis that is performed ahead of or as a part of video compression may identify spatial region labels as described above. Division into sub-streams may include detection of signals of regions and/or temporal regions of interest or the like by encoding device 104 as described above, and/or by a receiving device based on signaling from encoding device 104, and identifying sub-stream as containing a required and/or otherwise specified feature and/or set of features. Encoding device may alternatively identify a region of exclusion, identified as a region containing a feature to be excluded from a bitstream and/or sub-stream to be transmitted, for instance for reasons of privacy and/or security.

Still referring to FIG. 1, encoding device 104 may be configured to signal regions and/or blocks of interest and/or exclusion by signaling features in video blocks. For instance, and without limitation, encoding device 104 may include a datum in a bitstream and/or sub-stream indicating a block start code, an offset to a block position as identified by pixels from a corner and/or other reference point and/or origin of a frame, or the like. This may allow for quick access to block leveldata without decoding prior blocks. Still referring to FIG. 1, each non-overlapping block of a video frame may be divided into sub-blocks using a known method such as quad tree block partitioning. Blocks and/or sub-blocks may be sub-divided until sub-blocks have similar spatial characteristics. Traditional video encoding such as H.264 and H.265 uses block-based coding where blocks are typically coded in a raster scan order (leftto right and top-to-bottom). During decoding blocks may be decoded in order. This means decodingblock N of a video slice may require decoding all blocks before block N. Extracting data that corresponds to block N may thus require parsing all prior blocks and decoding block N may not be possible without decoding blocks 1 to N-1. For example, an application that requires only block N still may have to process all the blocks before N. A flexible bitstream that allows access to blocks, using block signaling, may be advantageous.

Start code such as 32-bit start codes as used in MPEG-2video may be used. Block header may include without limitation the following elements: (1) block type; (2) region identifier, (3) privacy flag; (4) coding type; (5) motion data; (6) texture data; and/or (7) color data.

Further referring to FIG. 1, block type may signal a type of information in an instant block. A fixed character number block type field, such as a four-character block type field, may be used to signal different types of blocks. This field may be used to signal semantics of block contents. For example, block type may signal that the block is part of a face by setting a block type value to FACE. A set of pre-defined block types may be defined to capture a set of commonly found objects. Table 1, below, lists exemplary block types that may be employed in a non-limiting, exemplary embodiment:

| Object | Block type code |
|---|---|
| Human face | FACE |
| Fruit | FRUT |
| Motor vehicle | AUTO |
| User defined object | UDEF |

When object type is user defined type (UDEF), it may be followed by a unique 128-bit object type. A value such as the Globally Unique Identifier (GUID) may be used to avoid name conflicts across services.

With continued reference to FIG. 1, in videos where a frame is partitioned into multiple spatial regions, a region identifier included in a block header may a spatial region a corresponding block belongs to. Region identifier may not be used in videos where spatial regions are not used.

With further reference to FIG. 1, block coding type may signal information needed and/or useful for decoding a block. Block coding type may include without limitation inter, intra, and/or independent. Inter blocks may information from previously decoded frames to more efficiently represent information in a current block. Intra blocks may use information from previously decoded blocks in the current frame to more efficiently represent information in the current block. A block type of ‘independent’ signals that a corresponding block does not use information from other blocks and is to be independently decoded.

Still referring to FIG. 1, motion data of a block may include motion information such as motion vectors, optical flow, or the like. Local and/or global motion may be included in motion vector data. Motion data may include translational motion or affine motion data.

Further referring to FIG. 1, Texture Data may represent a texture of a block. A transform such as the DCT may be used to represent texture. In such cases, texture may be compressed more efficiently using compression techniques such as intra block prediction.

Still referring to FIG. 1, color data may represent a color of a block. A method such as a color histogram may be used to represent color of a block. In some cases, where a block has single color, a more efficient way may be to signal the color components of that specific color. For example, RGB color representation may be used to represent color. Other color formats are possible, as may occur to persons skilled in the art upon reviewing the entirety of this disclosure.

Continuing to refer to FIG. 1, identification of a region, block, and/or set of blocks of interest may include identification of a region having a given type of motion data. For instance, and without limitation, a region, block, and/or set of blocks having a given type or element motion data may be signaled in a bitstream, enabling decoding of just those regions, blocks, and/or sets of blocks. Including a way to separate motion data without decoding the bitstream allows for fast extraction of sub-bitstreams. Specifying motion data size, in blocks, pixels, or other measurements, allows extracting only motion data in block and discarding texture data for specific applications. Similarly, texture data size may allow fast extraction of texture data bitstream. Alternatively, unique start codes for block motion data and block texture data may be used.

Still referring to FIG. 1, a block may have user defined features; such features may be signaled using a header that identifies user defined features, feature size, and feature data. Block level identification of such data may allow easy extraction of specific feature data as a sub bitstream. User defined features may include features that are input to neural networks at a receiver. Multiple neural networks may be trained with each network producing decisions that the network is trained on. Neural networks may use all or a subset of features computed from an edge device. Examples of neural networks include any neural networks as described in this disclosure, including without limitation convolutional neural networks, auto encoders, adversarial GNN, and multi-layer neural networks.

With further reference to FIG. 1, encoding device and/or analyzer may be configured to determine at least a scaling parameter for the spatial region. As used in this disclosure, a “scaling parameter” is a parameter dictating a change in height, width, and/or overall area of a frame or set of frames in a video. Scaling parameter may, for instance, include a number of pixels of height and/or width, a factor with which a current height and/or width is to be multiplied to obtain a new height and/or width, or the like. In an embodiment, a scaling parameter may be received from end user and/or a device operated thereby. Alternatively or additionally, end user 120 and/or end user device may transmit a screen size and/or picture size of a video to be viewed, which encoding device may use to determine scaling parameter. Alternatively or additionally, rescaling may be triggered by video content; for instance video may be rescaled to show a larger view and/or more details of a smaller or cropped area “zoom in” on a detected face, localized area of motion, and/or smaller region of interest as determined in any manner described in this disclosure, or may rescale to show a larger area to “zoom out” when a fast motion is detected and/or when detected region and/or regions of interest cover a larger portion of video area. Rescaling may be performed with or without resolution change.

Still referring to FIG. 1, in an embodiment, encoding device 104 may be configured to identify one or more temporal regions, such as without limitation one or more temporal regions of interest, in a video. A “temporal region,” as used in this disclosure, is a regions spanning time; a temporal region may include one or more frames and/or groups of pictures. Example of temporal regions may include without limitation scenes. Temporal regions may describe actions in a video over a period of time. For example, and without limitation, a temporal region may include a scene where a dog is chasing a ball; subsequent scene, which may be a different temporal region, may cut away from the dog and show the dog owner calling the dog.

With continued reference to FIG. 1, each temporal region may have different content and/or compression characteristics from each other temporal region. Content within a temporal region may not change much. There may be cases such as a scene where camera panning over a crowd at a stadium where boundaries of temporal regions are not clear and/or scene contents change within a temporal region. In an embodiment, encoding device 104 may identify temporal regions and/or boundaries therebetween by identifying temporal regions, such as sequences of frames, groups of pictures, or the like, containing one or more features of interest. For instance, and without limitation, where encoding device 104 has received an indication that human faces are features of interest, a sequence of frames containing human faces and/or a sequence of frames containing a specific human face of interest may be identified as a temporal region, and boundaries thereof may be frames that do not contain human faces and/or a specific human face of interest. Any feature of interest as described above, including audio features, motion, types of motion, or the like may be used to identify a temporal region of interest. A group of frames may be considered a temporal region when the frames have same contextual content. Temporal region may be defined by a single action, such as without limitation a person speaking, a person standing up, a person throwing a punch, or the like.

In an embodiment, and still referring to FIG. 1, encoding device 104 may be configured to signal a temporal region change. Some applications as described above may need only a sub-stream that has one key frame from a temporal region; for instance, an application counting temporal regions and/or features that temporal regions contain may only need one representative picture per temporal region. Alternatively or additionally, boundaries of temporal regions, such as temporal regions of videos without natural temporal region boundaries, such as surveillance video, live camera monitoring traffic, or the like, may be created at fixed intervals for instance and without limitation every 2 seconds, every 10 seconds, or the like. Temporal region duration selected for an application may take into account how content changes in video and select a time that is expected to keep region contents largely the same. Temporal region duration may, for instance, be set to a period within video in which motion, semantics information, regions of interest, metadata, and/or other detected and/or classified attributes remain within a threshold degree of similarity. Encoding device 104 may adaptively increase and decrease length of temporal regions based on activity measures, for instance by decreasing an interval whenever a change is detected and then slowly increasing the interval over time until a subsequent detection of change, for instance and without limitation as determined by detection of a change in video attributes exceeding some threshold.

Alternatively or additionally, and with further reference to FIG. 1, encoding device 104 may identify and/or signal temporal regions and/or boundaries thereof with absolute and/or real time; for instance, user instruction and/or instruction from a remote device may identify time period of interest, such as from 11 AM to 11:15 AM on Nov. 27, 2019. As a non-limiting example, in applications such as video surveillance, event time may have significance. Embedding real world time at temporal region boundaries, as identified for instance as described above, may allow applications to process regions relative to real world time.

Still referring to FIG. 1, a temporal region label may be added for each region signaled in a bitstream and/or sub-stream. Label may include a text descriptor, such as “running,” “interview,” or the like. A temporal region label may be signaled once in group of pictures header or a header common for a group of frames such as a sequence header or sequence parameter set. Alternatively or additionally, encoding device 104 may signal temporal regions at a block and/or spatial region level. Encoding device 104 may signal if a frame and/or temporal region contains a feature of interest such as without limitation a face, a skin, a vehicle, or the like. Content analysis that is performed ahead of or as a part of video compression may identify temporal region labels.

Still referring to FIG. 1, the encoding device 104 may be configured to determine at least a speed parameter of the temporal region. A speed parameter may indicate a playback speed of a temporal region. As a non-limiting example, temporal regions without activity may be sped up, permitting efficient video summarization. More generally, a speed parameter may be specified as a playback coefficient ranging from 0 to N, where values from 0 to 1 would slow down playback and values from 1 to N would speed it up, for instance by multiplying input framerate by the playback coefficient. In an embodiment, encoding device may “speed up” a temporal region by dropping frames and/or slow down a temporal region by reintroducing and/or not dropping frames; additional frames may be introduced for a slower speed by, for instance, interpolation and/or upsampling to generate luma and/or chroma values for newly introduced intervening frames. Speed parameter may permit video summarization, whereby temporal regions of interest may be played more slowly while temporal regions that are not of interest may be “fast forwarded” or otherwise more rapidly traversed.

Continuing to refer to FIG. 1, encoding device 104 and/or analyzer 112 may select a plurality of regions of interest. For instance, and without limitation, at least a region of interest may include a first region of interest and a second region of interest.

Still referring to FIG. 1, encoding device 104 may include an encoder 124, which may be implemented in any manner suitable for implementation of any computing device, module, and/or component of encoding device 104 as described above. Modules and/or components described as included in encoder 124 are presented for exemplary purposes only; functions and/or structure pertaining to each such module and/or component may be implemented in any alternative or additional manner in encoding device 104 and/or any component, module, and/or device incorporated in or communicatively connected to encoding device 104, in any manner that may occur to persons skilled in the art, upon reviewing the entirety of this disclosure.

With continued reference to FIG. 1, encoder 124 may include a component that receives, from analyzer, annotations of input video along with encoding parameters. Annotations may be related to the spatial and/or the temporal domain. Examples of annotations in the spatial domain are coordinates of the region of interest of input video to be encoded; scaling parameters for video resizing; areas of input video that need to be obfuscated. Examples of annotations in the temporal domain are timestamps of portions of the input video that need to be encoded; timestamps of actions within the video that need to be encoded with the specified speed parameters; timestamps of the audio streams that need to be encoded. Once portions of input video that to be encoded are identified the encoder 124 may encoding parameters for each of the portions. Examples of encoder 124 parameters may include quantization levels for the portion of video; scaling parameters for frame resizing; framerates for temporal video portions.

Further referring to FIG. 1, encoder 124 is configured to encode at least an output video 128 as a function of the input video and the at least a region of interest. At least an output video 128 may have at least a second data volume, and the at least a second data volume is less than the first data volume; in other words at least an output video 128 may contain a strict subset of data from the at least an input video encoding the at least an output video 128 may include encoding a first output video 128 based on a first region of interest and encoding a second output video 128 based on a second region of interest. Alternatively, a first region of interest may be combined with a second region of interest; for instance, a first region of interest may be displayed simultaneously with a second region of interest in a single frame or may share frames for a series of frames. Alternatively or additionally, where a first region of interest is temporal and a second region of interest is temporal, the regions may be combined in series. Where a regions are both temporal and spatial, they may be combined spatially in some frames and not in others; a video may, for instance, combine two regions together at some moments, alternate between them at other moments, and/or show one or the other exclusively. Persons skilled in the art, upon reviewing the entirety of this disclosure, will be aware of various ways in which different regions of interest may be combined in a single video. Once output video 128 is encoded, it may be transmitted to one or more end users.

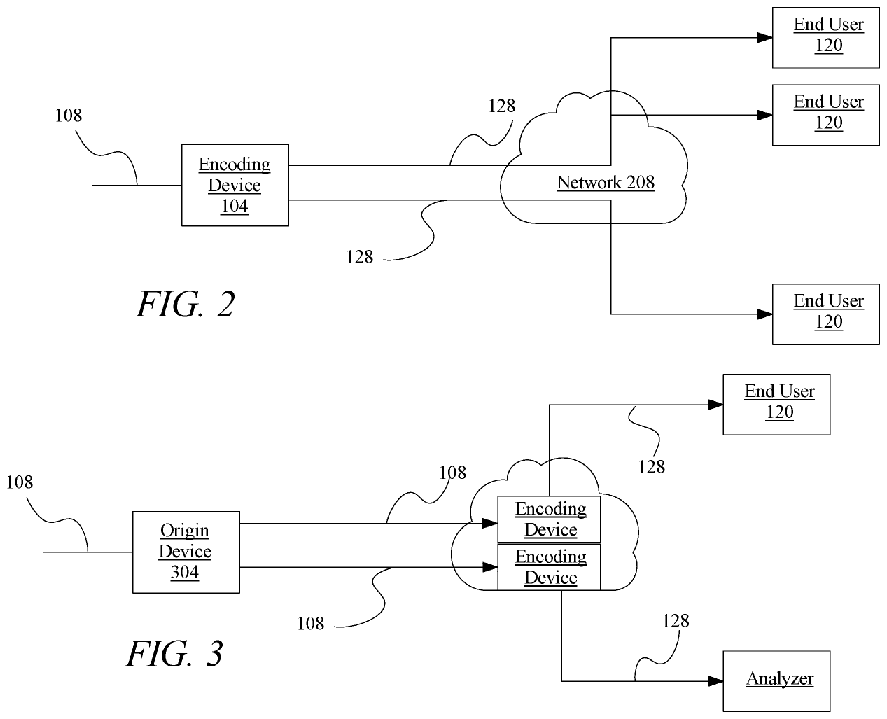

Referring now to FIG. 2, an exemplary process flow using encoding device 104 is illustrated. In an embodiment, encoding device receives input video, which may be received in any manner described above. For instance, and without limitation, encoding device may be, be included in, and/or include a video source, where a “video source” is a device that captures and/or produces input video 108. One or more different variants 204a-b of the video may then distributed to end users over a network 208, which may include without limitation the Internet. In an embodiment, one video output may be distributed to one or multiple users. Each output video 128 need not be similar to any other output video 128. Input video may be analyzed based on end user information that is either stored or received end user in real time. Each end user may receive a most suitable output video 128 as a result of identification of features as described above.

Referring now to FIG. 3, in an exemplary embodiment, encoding device 104 may be implemented at an arbitrary network node between an origin as described above and an end user. One or many of such nodes including an encoding device 104 as described in this disclosure may be distributed in the network. Each such node may receive input video from origin and process, generate output video 128, encode output video 128, and/or send output video 128 to one or more end users.

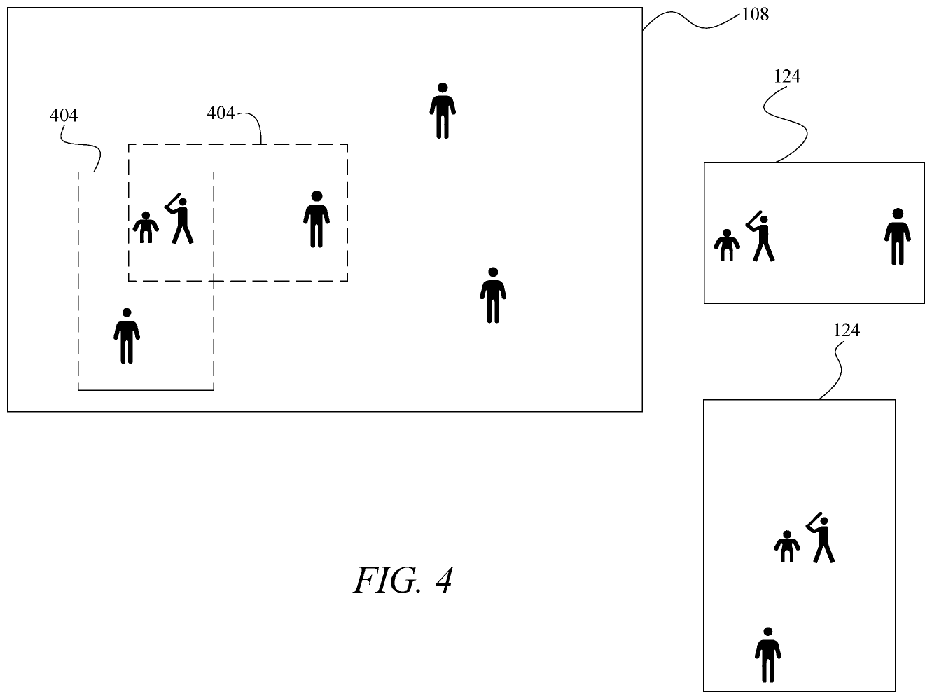

Referring now to FIG. 4, an exemplary embodiment of a process of compositional encoding is illustrated. In an embodiment, input video 108 may include a very high-resolution stream that shows an entire field at a sports event, such as a baseball game. Encoding device 104 and/or analyzer 112 may detect action and identify region of interest (ROI) 404 where the most intense action is happening. This region may alternatively be identified by end user feedback in the form of a metadata, or in any other manner described above. Once coordinates of the region are annotated, this information may be forwarded to encoder 124; encoder 124 and/or encoding device 104 may encode just ROI portion for output, reducing input resolution (W×H) to a reduced resolution such as quarter resolution (W/4×H/4). One example is an input video 108 of “8K” resolution (7680×4320 pixels), with the output video 128 of the “HD” resolution (1920×1080 pixels). There may be multiple ROI, which may be transformed to multiple output videos 128 as illustrated in FIG. 4.

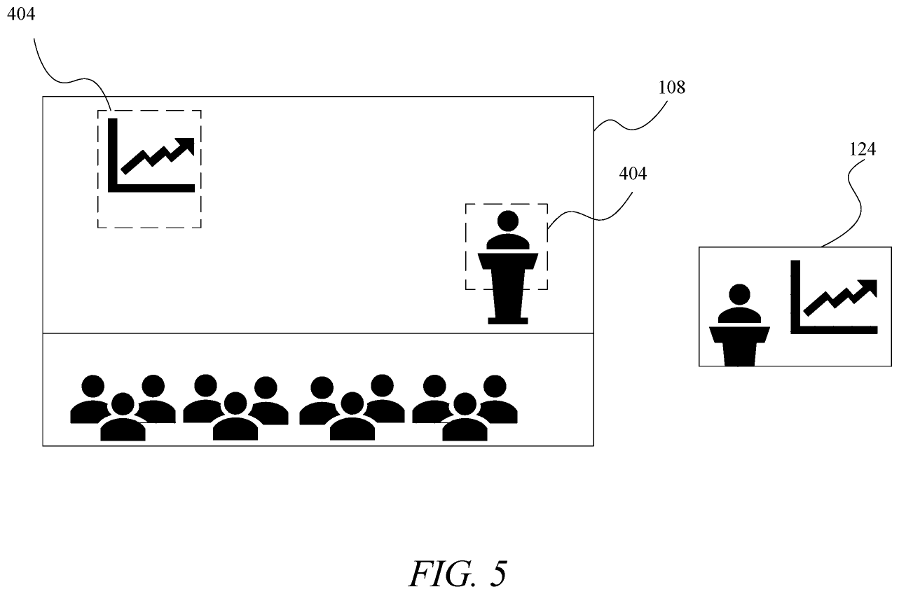

Referring now to FIG. 5, a further non-limiting example of an embodiment of video composition is provided. Input video 108 may include a stream showing a lecture hall, conference room, or the like with a presenter and a presentation. Encoding device 104 and/or analyzer may detect a person, such as without limitation a lecturer or presenter, and an area that changes in time, such as a presentation, slideshow and/or projector screen or the like, hence identifying two regions of interest ROI 1 and ROI. Alternatively or additionally, information may be obtained from end user feedback in the form of a metadata, or otherwise determined as described above. Analyzer may pass to encoder 124 coordinates of ROI 1 and ROI 2 together with spatial layout information. Encoder 124 and/or encoding device 104 may produce output video 128 by composing and/or combining two ROIs. Note that one or more ROIs that may be used to compose output video 128 might not fit exactly a rectangle of specified resolution. In such cases, areas outside of ROIs may be filled with pixel values that optimize encoding performance. For example, an area around an ROI may be filled with pixels with same values as ROI background or filled with pixel values that produce best compression on their own.

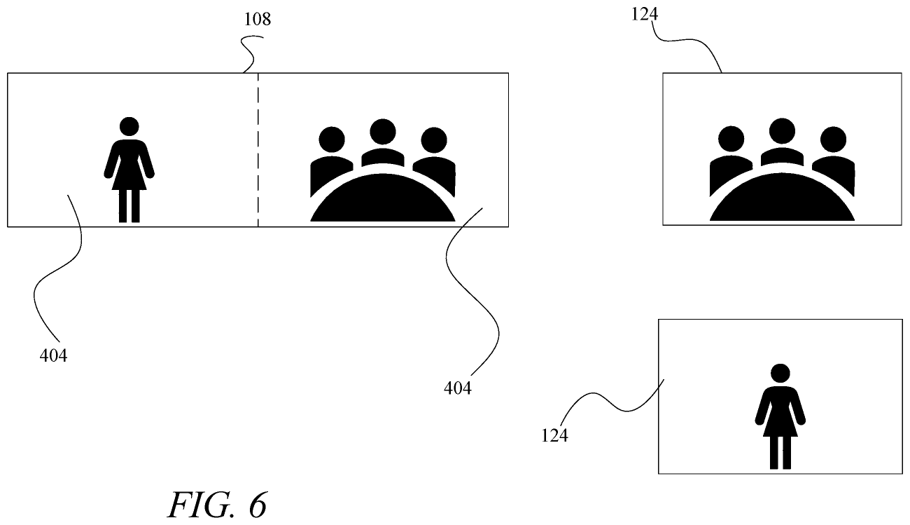

Referring now to FIG. 6, an additional exemplary embodiment of video composition is illustrated. Input video 108 may include a stream presenting two separate scenes. For example, on a left side may be field reporter for a TV station, while on the left may be a studio feed with anchors. Analyzer may detect different scenes and/or receive such information via metadata or otherwise determine scenes as ROI as described above. Analyzer may detect voices based on input audio streams and assign voice identifiers to left and right portions of video. Based on when reporter or anchors are speaking, output video 128 may be composed of either left or right region of input video 108. For example, in FIG. 6, output stream may be composed and encoded as a right region at time T₁, while it may be composed and encoded as left region starting at time T₂. There may be other examples that represent combination of previous examples and obvious extensions of previous examples. Any combination of one or more spatial and temporal regions and timestamps may be viewed as within the scope of this disclosure.

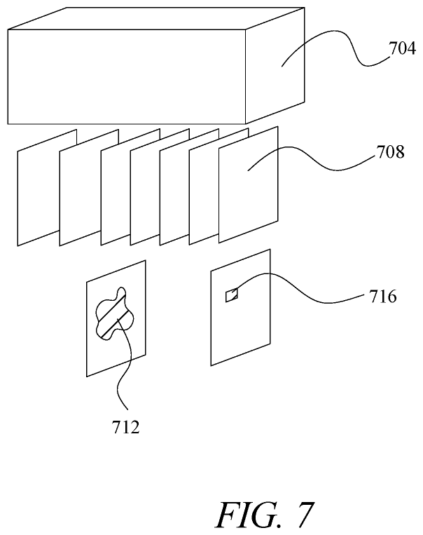

Referring to FIG. 7, embodiments described in this disclosure may involve implementation and/or performance of one or more processes of video compression. As used in this disclosure, video compression is a process for removing redundancy and compressing a video 704. Video compression methods may use motion compensation to reduce temporal redundancy, transform coding to reduce spatial redundancy, and entropy coding methods such as variable length coding and/or binary arithmetic coding to reduce statistical redundancies in symbols/parameters produced by motion compensation and/or transform coding. In a typical video compression system, a frame 708 of a video may be divided into non-overlapping blocks and each block may undergo motion compensation and/or transform coding followed by entropy coding. A transform coding stage may reduce spatial redundancies and may essentially be characterized as encoding texture in video. A quantization stage may follow transform coding where transform coefficients may be quantized into fewer levels. A quantization stage may add loss and/or distortion to transform coefficients. A similar quantization process may also be used to quantize motion information (e.g., motion vectors) and include information at various levels of accuracy. Motion vectors and transform coefficients may be coded with different levels of quantization.

Still referring to FIG. 7, a video 704 may be made up of a plurality of frames 708. Each frame may be encoded as an optional set of spatial regions 712. A spatial region 712 may be an entire frame. When a frame is divided into more than one spatial region, region identifiers may be used at block level to signal spatial regions to which a block 716 belongs. Each block 716 may be a non-overlapping set of pixels; that is, pixels of one block may not overlap with other blocks in a given characterization and/or division of a video. Blocks may have any shape including without limitation a rectangular shape. A block 716 may be sub-divided into smaller sub-blocks. Each of sub-blocks may be further sub-divided into smaller sub-blocks. One reason for such sub-division may be to identify blocks that belong to a single spatial region or identify blocks where all pixels of a block 716 have the same or similar feature such as motion, luminance, or color. Another reason for such partition may be to achieve a more efficient representation that reduces bits required for the representation. Outputs of neural networks, machine-learning models, and/or machine-learning processes may identify blocks, sub-blocks, and/or other units of video data corresponding to and/or containing features.

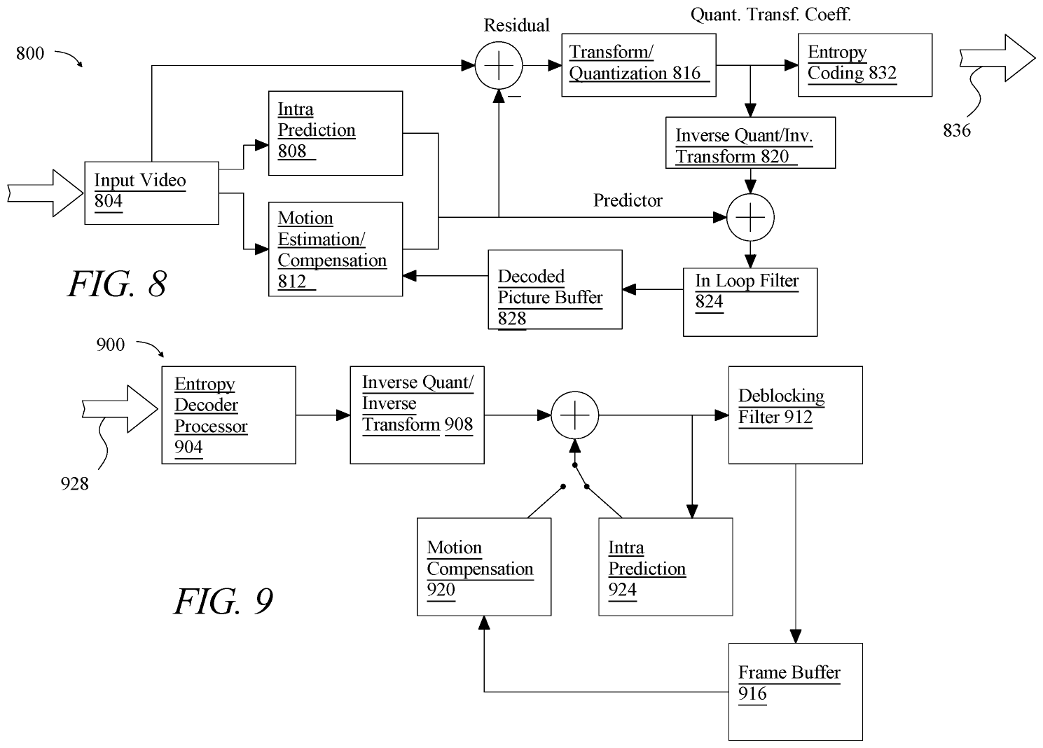

FIG. 8 is a system block diagram illustrating an exemplary embodiment of a video encoder 800, which may include and/or be included in encoder 124, capable of constructing a motion vector candidate list including adding a global motion vector candidate to the motion vector candidate list. Example video encoder 800 may receive an input video 804, which may be initially segmented or dividing according to a processing scheme, such as a tree-structured macro block partitioning scheme (e.g., quad-tree plus binary tree). An example of a tree-structured macro block partitioning scheme may include partitioning a picture frame into large block elements called coding tree units (CTU). In some implementations, each CTU may be further partitioned one or more times into a number of sub-blocks called coding units (CU). A final result of this portioning may include a group of sub-blocks that may be called predictive units (PU). Transform units (TU) may also be utilized.

Still referring to FIG. 8, example video encoder 800 may include an intra prediction processor 808, a motion estimation/compensation processor 812, which may also be referred to as an inter prediction processor, capable of constructing a motion vector candidate list including adding a global motion vector candidate to the motion vector candidate list, a transform/quantization processor 816, an inverse quantization/inverse transform processor 820, an in-loop filter 824, a decoded picture buffer 828, and/or an entropy coding processor 832. Bit stream parameters may be input to the entropy coding processor 832 for inclusion in the output bit stream 836.

In operation, and with continued reference to FIG. 8, for each block of a frame of input video 804, whether to process block via intra picture prediction or using motion estimation/compensation may be determined. Block may be provided to intra prediction processor 808 or motion estimation/compensation processor 812. If block is to be processed via intra prediction, intra prediction processor 808 may perform processing to output a predictor. If block is to be processed via motion estimation/compensation, motion estimation/compensation processor 812 may perform processing including constructing a motion vector candidate list including adding a global motion vector candidate to the motion vector candidate list, if applicable.

Further referring to FIG. 8, a residual may be formed by subtracting a predictor from input video 108. Residual may be received by transform/quantization processor 816, which may perform transformation processing (e.g., discrete cosine transform (DCT)) to produce coefficients, which may be quantized. Quantized coefficients and any associated signaling information may be provided to entropy coding processor 832 for entropy encoding and inclusion in output bit stream 836. Entropy encoding processor 832 may support encoding of signaling information related to encoding a current block. In addition, quantized coefficients may be provided to inverse quantization/inverse transformation processor 820, which may reproduce pixels, which may be combined with a predictor and processed by in loop filter 824, an output of which may be stored in decoded picture buffer 828 for use by motion estimation/compensation processor 812 that is capable of constructing a motion vector candidate list including adding a global motion vector candidate to the motion vector candidate list.

With continued reference to FIG. 8, although a few variations have been described in detail above, other modifications or additions are possible. For example, in some implementations, current blocks may include any symmetric blocks (8×8, 16×16, 32×32, 64×64, 128×128, and the like) as well as any asymmetric block (8×4, 16×8, and the like).

In some implementations, and still referring to FIG. 8, a quadtree plus binary decision tree (QTBT) may be implemented. In QTBT, at a Coding Tree Unit level, partition parameters of QTBT may be dynamically derived to adapt to local characteristics without transmitting any overhead. Subsequently, at a Coding unit level, a joint-classifier decision tree structure may eliminate unnecessary iterations and control the risk of false prediction. In some implementations, LTR frame block update mode may be available as an additional option available at every leaf node of QTBT.

In some implementations, and still referring to FIG. 8, additional syntax elements may be signaled at different hierarchy levels of bitstream. For example, a flag may be enabled for an entire sequence by including an enable flag coded in a Sequence Parameter Set (SPS). Further, a CTU flag may be coded at a coding tree unit (CTU) level.

FIG. 9 is a system block diagram illustrating an example decoder 900 capable of decoding a bitstream 928 by at least constructing a motion vector candidate list including adding a global motion vector candidate to the motion vector candidate list. Decoder 900 may include an entropy decoder processor 904, an inverse quantization and inverse transformation processor 908, a deblocking filter 912, a frame buffer 916, a motion compensation processor 920 and/or an intra prediction processor 924.

In operation, and still referring to FIG. 9, bit stream 928 may be received by decoder 900 and input to entropy decoder processor 904, which may entropy decode portions of bit stream into quantized coefficients. Quantized coefficients may be provided to inverse quantization and inverse transformation processor 908, which may perform inverse quantization and inverse transformation to create a residual signal, which may be added to an output of motion compensation processor 920 or intra prediction processor 924 according to a processing mode. An output of the motion compensation processor 920 and intra prediction processor 924 may include a block prediction based on a previously decoded block. A sum of prediction and residual may be processed by deblocking filter 912 and stored in a frame buffer 916.

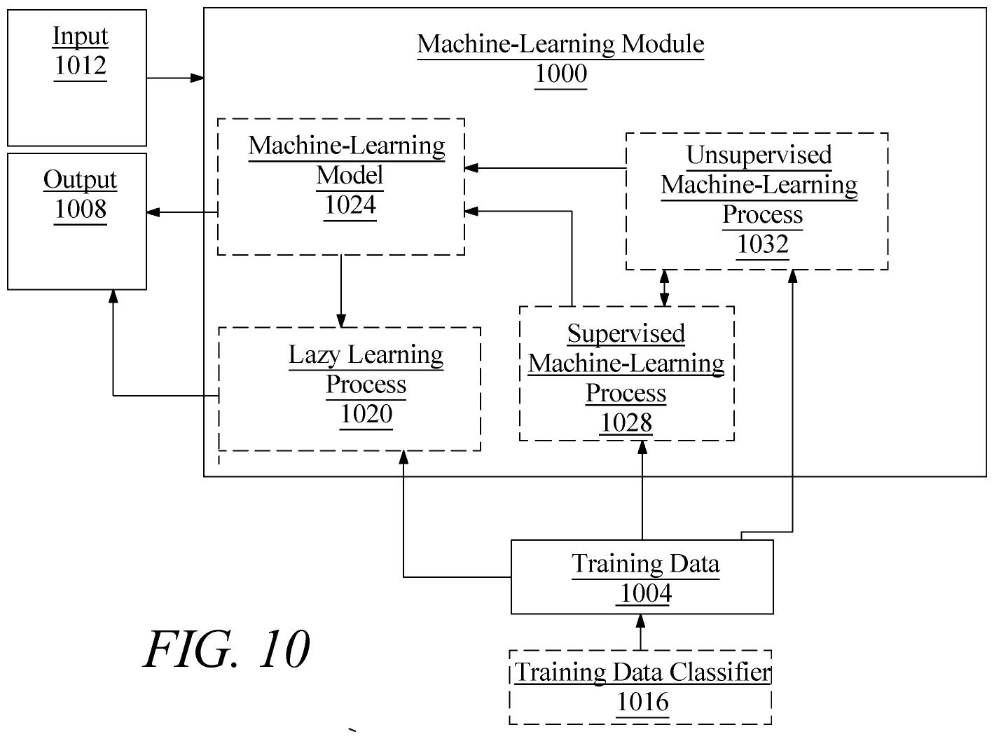

Referring now to FIG. 10, an exemplary embodiment of a machine-learning module 1000 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 1004 to generate an algorithm that will be performed by a computing device/module to produce outputs 1008 given data provided as inputs 1012; this is in contrast to a non-machine learning software program where the commands to be executed are determined in advance by a user and written in a programming language.

Still referring to FIG. 10, “training data,” as used herein, is data containing correlations that a machine-learning process may use to model relationships between two or more categories of data elements. For instance, and without limitation, training data 1004 may include a plurality of data entries, each entry representing a set of data elements that were recorded, received, and/or generated together; data elements may be correlated by shared existence in a given data entry, by proximity in a given data entry, or the like. Multiple data entries in training data 1004 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 1004 according to various correlations; correlations may indicate causative and/or predictive links between categories of data elements, which may be modeled as relationships such as mathematical relationships by machine-learning processes as described in further detail below. Training data 1004 may be formatted and/or organized by categories of data elements, for instance by associating data elements with one or more descriptors corresponding to categories of data elements. As a non-limiting example, training data 1004 may include data entered in standardized forms by persons or processes, such that entry of a given data element in a given field in a form may be mapped to one or more descriptors of categories. Elements in training data 1004 may be linked to descriptors of categories by tags, tokens, or other data elements; for instance, and without limitation, training data 1004 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 10, training data 1004 may include one or more elements that are not categorized; that is, training data 1004 may not be formatted or contain descriptors for some elements of data. Machine-learning algorithms and/or other processes may sort training data 1004 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 1004 to be made applicable for two or more distinct machine-learning algorithms as described in further detail below. Training data 1004 used by machine-learning module 1000 may correlate any input data as described in this disclosure to any output data as described in this disclosure.

Further referring to FIG. 10, training data may be filtered, sorted, and/or selected using one or more supervised and/or unsupervised machine-learning processes and/or models as described in further detail below; such models may include without limitation a training data classifier 1016. Training data classifier 1016 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 1000 may generate a classifier using a classification algorithm, defined as a processes whereby a computing device and/or any module and/or component operating thereon derives a classifier from training data 1004. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Still referring to FIG. 10, machine-learning module 1000 may be configured to perform a lazy-learning process 1020 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 1004. Heuristic may include selecting some number of highest-ranking associations and/or training data 1004 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 10, machine-learning processes as described in this disclosure may be used to generate machine-learning models 1024. A “machine-learning model,” as used in this disclosure, is a mathematical and/or algorithmic representation of a relationship between inputs and outputs, as generated using any machine-learning process including without limitation any process as described above and stored in memory; an input is submitted to a machine-learning model 1024 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 1024 may be generated by creating an artificial neural network, such as a convolutional neural network comprising an input layer of nodes, one or more intermediate layers, and an output layer of nodes. Connections between nodes may be created via the process of “training” the network, in which elements from a training data 1004 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 10, machine-learning algorithms may include at least a supervised machine-learning process 1028. At least a supervised machine-learning process 1028, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include inputs as described in this disclosure as inputs, outputs as described in this disclosure as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 1004. Persons skilled in the art, upon reviewing the entirety of this disclosure, will be aware of various possible variations of at least a supervised machine-learning process 1028 that may be used to determine relation between inputs and outputs. Supervised machine-learning processes may include classification algorithms as defined above.

Further referring to FIG. 10, machine learning processes may include at least an unsupervised machine-learning processes 1032. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 10, machine-learning module 1000 may be designed and configured to create a machine-learning model 1024 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 10, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

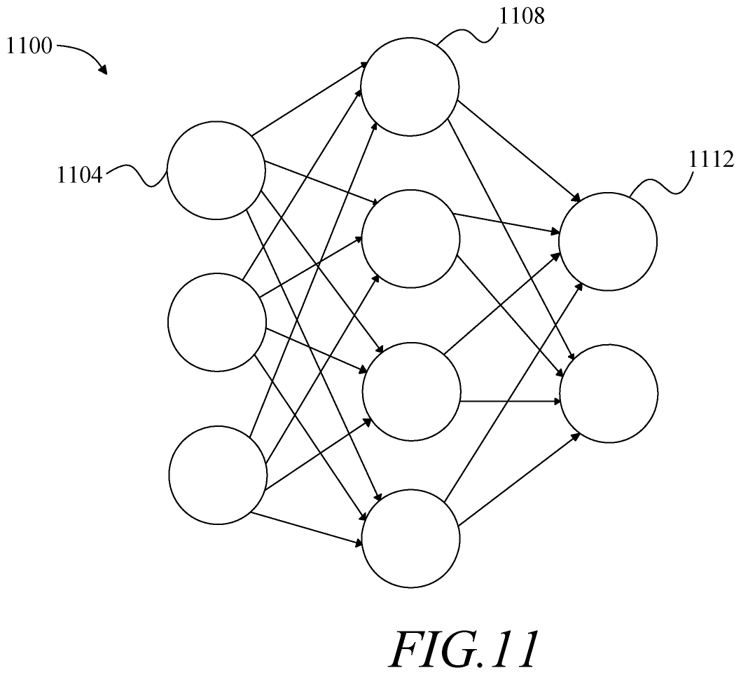

Referring now to FIG. 11, an exemplary embodiment of neural network 1100 is illustrated. Neural network 1100, also known as an artificial neural network, is a network of “nodes,” or data structures having one or more inputs, one or more outputs, and a function determining outputs based on inputs. Such nodes may be organized in a network, such as without limitation a convolutional neural network, including an input layer 1104 of nodes, one or more intermediate 1108 layers, and an output layer 1112 of nodes. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

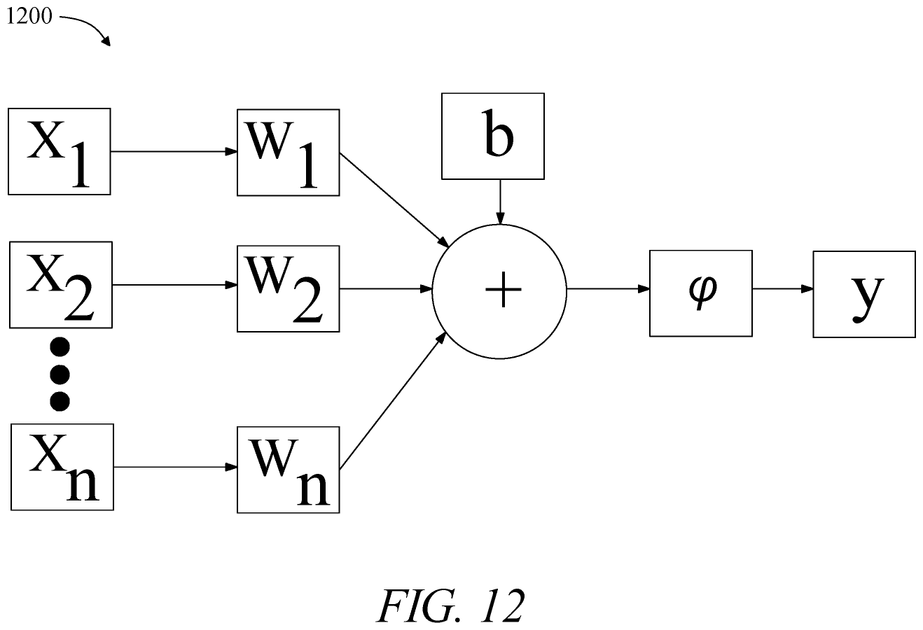

Referring now to FIG. 12, an exemplary embodiment 1600 of a node of a neural network is illustrated. A node may include, without limitation a plurality of inputs xᵢ that may receive numerical values from inputs to a neural network containing the node and/or from other nodes. Node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

Still referring to FIG. 12, a neural network may receive semantic units as inputs and output vectors representing such semantic units according to weights wᵢ that are derived using machine-learning processes as described in this disclosure.

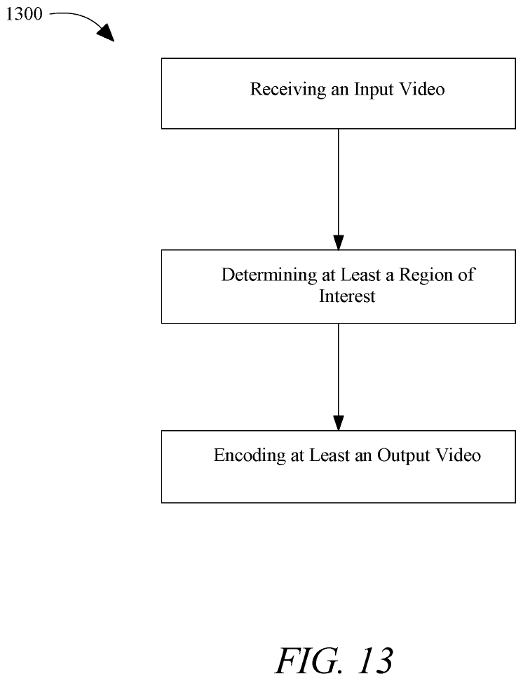

Referring now to FIG. 13, an exemplary embodiment of a method 1305 of video analysis and composition is illustrated. At step 1305, an encoding device receives an input video having a first data volume; this may be implemented, without limitation as described above in reference to FIGS. 1-12.

At step 1310, and still referring to FIG. 13, encoding device determines at least a region of interest of input video; this may be implemented, without limitation, as described above in reference to FIGS. 1-12. In an embodiment, determining at least a region of interest may include detecting an area of motion in the input video and determining the at least a region of interest based on the area of motion. Determining at least a region of interest may include identifying at least a feature of interest in the input video and determining the at least a region of interest based on the at least a feature of interest. Identifying at least a feature of interest may include identifying the at least a feature of interest using a neural network. Identifying at least a feature of interest may include identifying the at least a feature of interest using at least a recipient input. At least a region of interest may include a spatial region of input video. Encoding device may determine at least a scaling parameter for the spatial region. At least a region of interest may include a temporal region of the input video. Encoding device may determine at least a speed parameter of the temporal region.

At step 1315, and continuing to refer to FIG. 13, encoding device encodes at least an output video 128 as a function of the input video and the at least a region of interest; this may be implemented, without limitation, as described above in reference to FIGS. 1-12. At least an output video US may have at least a second data volume. At least a second data volume may be less than the first data volume. Encoding at least an output video 128 may include encoding a first output video 128 based on first region of interest and encoding a second output video 128 based on second region of interest.

It is to be noted that any one or more of the aspects and embodiments described herein may be conveniently implemented using digital electronic circuitry, integrated circuitry, specially designed application specific integrated circuits (ASICs), field programmable gate arrays (FPGAs) computer hardware, firmware, software, and/or combinations thereof, as realized and/or implemented in one or more machines (e.g., one or more computing devices that are utilized as a user computing device for an electronic document, one or more server devices, such as a document server, etc.) programmed according to the teachings of the present specification, as will be apparent to those of ordinary skill in the computer art. These various aspects or features may include implementation in one or more computer programs and/or software that are executable and/or interpretable on a programmable system including at least one programmable processor, which may be special or general purpose, coupled to receive data and instructions from, and to transmit data and instructions to, a storage system, at least one input device, and at least one output device. Appropriate software coding may readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, Programmable Logic Devices (PLDs), and/or any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

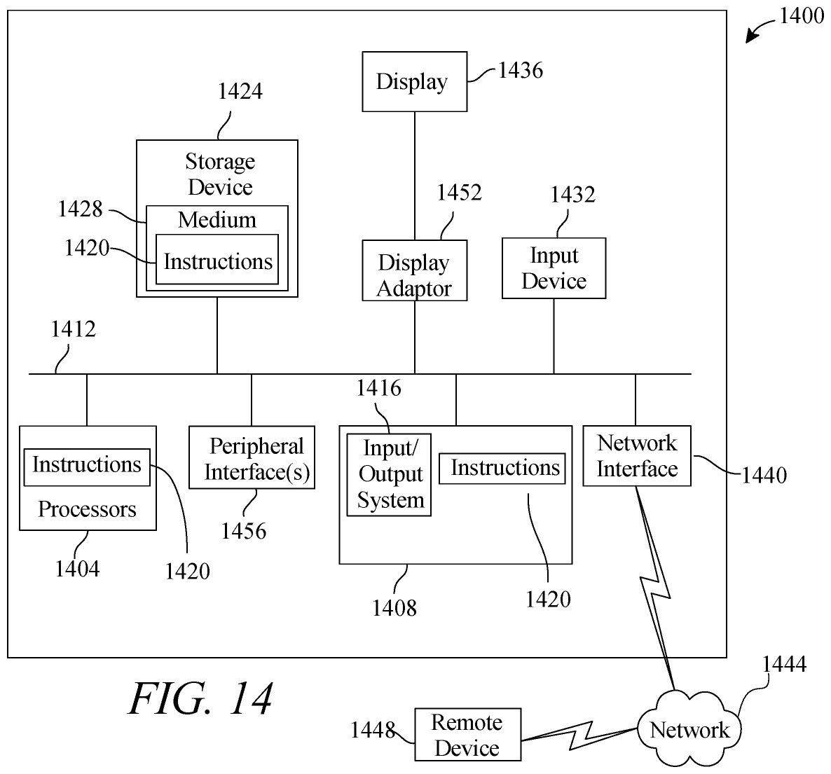

FIG. 14 shows a diagrammatic representation of one embodiment of a computing device in the exemplary form of a computer system 1400 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1400 includes a processor 1404 and a memory 1408 that communicate with each other, and with other components, via a bus 1412. Bus 1412 may include any of several types of bus structures including, but not limited to, a memory bus, a memory controller, a peripheral bus, a local bus, and any combinations thereof, using any of a variety of bus architectures.

Memory 1408 may include various components (e.g., machine-readable media) including, but not limited to, a random-access memory component, a read only component, and any combinations thereof. In one example, a basic input/output system 1416 (BIOS), including basic routines that help to transfer information between elements within computer system 1400, such as during start-up, may be stored in memory 1408. Memory 1408 may also include (e.g., stored on one or more machine-readable media) instructions (e.g., software) 1420 embodying any one or more of the aspects and/or methodologies of the present disclosure. In another example, memory 1408 may further include any number of program modules including, but not limited to, an operating system, one or more application programs, other program modules, program data, and any combinations thereof.

Computer system 1400 may also include a storage device 1424. Examples of a storage device (e.g., storage device 1424) include, but are not limited to, a hard disk drive, a magnetic disk drive, an optical disc drive in combination with an optical medium, a solid-state memory device, and any combinations thereof. Storage device 1424 may be connected to bus 1412 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1424 (or one or more components thereof) may be removably interfaced with computer system 1400 (e.g., via an external port connector (not shown)). Particularly, storage device 1424 and an associated machine-readable medium 1428 may provide nonvolatile and/or volatile storage of machine-readable instructions, data structures, program modules, and/or other data for computer system 1400. In one example, software 1420 may reside, completely or partially, within machine-readable medium 1428. In another example, software 1420 may reside, completely or partially, within processor 1404.

Computer system 1400 may also include an input device 1432. In one example, a user of computer system 1400 may enter commands and/or other information into computer system 1400 via input device 1432. Examples of an input device 1432 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1432 may be interfaced to bus 1412 via any of a variety of interfaces (not shown) including, but not limited to, a serial interface, a parallel interface, a game port, a USB interface, a FIREWIRE interface, a direct interface to bus 1412, and any combinations thereof. Input device 1432 may include a touch screen interface that may be a part of or separate from display 1436, discussed further below. Input device 1432 may be utilized as a user selection device for selecting one or more graphical representations in a graphical interface as described above.

A user may also input commands and/or other information to computer system 1400 via storage device 1424 (e.g., a removable disk drive, a flash drive, etc.) and/or network interface device 1440. A network interface device, such as network interface device 1440, may be utilized for connecting computer system 1400 to one or more of a variety of networks, such as network 1444, and one or more remote devices 1448 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1444, may employ a wired and/or a wireless mode of communication. In general, any network topology may be used. Information (e.g., data, software 1420, etc.) may be communicated to and/or from computer system 1400 via network interface device 1440.

Computer system 1400 may further include a video display adapter 1452 for communicating a displayable image to a display device, such as display device 1436. Examples of a display device include, but are not limited to, a liquid crystal display (LCD), a cathode ray tube (CRT), a plasma display, a light emitting diode (LED) display, and any combinations thereof. Display adapter 1452 and display device 1436 may be utilized in combination with processor 1404 to provide graphical representations of aspects of the present disclosure. In addition to a display device, computer system 1400 may include one or more other peripheral output devices including, but not limited to, an audio speaker, a printer, and any combinations thereof. Such peripheral output devices may be connected to bus 1412 via a peripheral interface 1456. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve embodiments as disclosed herein. Accordingly, this description is meant to be taken only by way of example, and not to otherwise limit the scope of this invention.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. An encoding device for video analysis and composition, the encoding device comprising circuitry configured to:
receive an input video having a first data volume;
determine at least a region of interest of the input video; and
encode at least an output video as a function of the input video and t at least a region of
interest, wherein:
the at least an output video has at least a second data volume; and
the at least a second data volume is less than the first data volume.

2. The encoding device of claim 1, wherein determining the at least a region of interest further comprises:
detecting an area of motion in the input video; and
determining the at least a region of interest based on the area of motion.

3. The encoding device of claim 1, wherein determining the at least a region of interest further comprises:
identifying at least a feature of interest in the input video; and
determining the at least a region of interest based on the at least a feature of interest.

4. The encoding device of claim 3, further configured to identify the at least a feature of interest using a neural network.

5. The encoding device of claim 3, further configured to identify the at least a feature of interest using at least a recipient input.

6. The encoding device of claim 1, wherein the at least a region of interest further comprises a spatial region of the input video.

7. The encoding device of claim 6, further configured to determine at least a scaling parameter for the spatial region.

8. The encoding device of claim 1, wherein the at least a region of interest further comprises a temporal region of the input video.

9. The encoding device of claim 8, further configured to determine at least a speed parameter of the temporal region.

10. The encoding device of claim 1, wherein:
the at least a region of interest further comprises a first region of interest and a second region of interest; and
encoding the at least an output video further comprises:
encoding a first output video based on the first region of interest; and
encoding a second output video based on the second region of interest.

11. A method of video analysis and composition, the method comprising:
receiving, by an encoding device, an input video having a first data volume;
determining, by the encoding device, at least a region of interest of the input video; and
encoding, by the encoding device, at least an output video as a function of the input video
and the at least a region of interest, wherein:
the at least an output video has at least a second data volume; and
the at least a second data volume is less than the first data volume.

12. The method of claim 11, wherein determining the at least a region of interest further comprises:
detecting an area of motion in the input video; and
determining the at least a region of interest based on the area of motion.

13. The method of claim 11, wherein determining the at least a region of interest further comprises:
identifying at least a feature of interest in the input video; and
determining the at least a region of interest based on the at least a feature of interest.

14. The method of claim 13, further comprising identifying the at least a feature of interest using a neural network.

15. The method of claim 13, further comprising identifying the at least a feature of interest using at least a recipient input.

16. The method of claim 11, wherein the at least a region of interest further comprises a spatial region of the input video.

17. The method of claim 16, further comprising determining at least a scaling parameter for the spatial region.

18. The method of claim 11, wherein the at least a region of interest further comprises a temporal region of the input video.

19. The method of claim 18, further comprising determining at least a speed parameter of the temporal region.

20. The method of claim 11, wherein:
the at least a region of interest further comprises a first region of interest and a second region of interest; and
encoding the at least an output video further comprises:
encoding a first output video based on the first region of interest; and
encoding a second output video based on the second region of interest.
